(19) United States
(12) Patent Application Publication
(10) Pub. No.: US 2026/0080803 A1
(43) Pub. Date: Mar. 19, 2026

(54) SIMULATED ABDOMINAL WALL

(71) Applicant: Applied Medical Resources Corporation, Rancho Santa Margarita, CA (US)

(72) Inventors: Gregory K. Hofstetter, Lake Forest, CA (US); Tracy Breslin, Trabuco Canyon, CA (US); Joel B. Velasco, Rancho Santa Margarita, CA (US)

(21) Appl. No.: 19/400,143

(22) Filed: Nov. 25, 2025

Related U.S. Application Data
(63) Continuation of application No. 18/520,973, filed on Nov. 28, 2023, now Pat. No. 12,482,378.
Application No. 18/520,973 is a continuation of application No. 17/474,534, filed on Sep. 14, 2021, now Pat. No. 11,830,378.
Application No. 17/474,534 is a continuation of application No. 16/018,361, filed on Jun. 26, 2018, now Pat. No. 11,120,708.

(51) Int. Cl. G09B 23/28; G09B 23/30

(52) U.S. Cl. CPC G09B 23/285; G09B 23/30

(57) ABSTRACT

A simulated abdominal wall for laparoscopic surgical training and methods of making the wall are provided. The simulated abdominal wall is dome-shaped having a visual appearance of an insufflated abdomen. Also, the wall is strong enough to withstand penetration with surgical trocars without unrealistic buckling or deformation. The wall is supported by a frame along the perimeter without any support structures traversing the wall that would interfere with port placement. The wall includes multiple layers connected together to form a unitary wall to fit a laparoscopic trainer. In one method, a projection of a dome is cut from a flat layer of foam material and assembled within a mold cavity. Consecutive layers with the same or different projection pattern are laid up inside the mold cavity. In another method, a vacuum mold together with heat is used to deform each foam layer. Adhesive is applied between layers to simultaneously join the adjacent layers upon deformation.

### CROSS-REFERENCE TO RELATED APPLICATIONS

This patent application is a continuation of U.S. Application No. Ser. No. 18/520,973 filed on Nov. 28, 2023 entitled “Simulated abdominal wall” which is a continuation of U.S. Application No. Ser. No. 17/474,534 filed on Sep. 14, 2021, now issued U.S. Pat. No. 11,830,378 entitled “Simulated abdominal wall” which is a continuation of U.S. Application No. Ser. No. 16/018,361 filed on Jun. 26, 2018, now issued U.S. Pat. No. 11,120,708 entitled “Simulated abdominal wall” which is a continuation of International Patent Application No. PCT/US2017/039113 entitled “Simulated abdominal wall” filed on Jun. 23, 2017 which claims priority to and benefit of U.S. Provisional Patent Application Ser. No. 62/355,170 entitled “Simulated abdominal wall” filed on Jun. 27, 2016 all incorporated herein by reference in their entirety.

### FIELD OF THE INVENTION

The present invention relates to the field of surgical training and simulation and more specifically, to a simulated abdominal wall for training laparoscopic surgical skills.

### BACKGROUND OF THE INVENTION

Minimally invasive surgical techniques such as laparoscopic surgery can greatly improve patient outcomes because of reduced trauma to the body. There is, however, a steep learning curve associated with minimally invasive surgery. Accordingly, laparoscopic simulators, also known as trainers, have been developed to facilitate training surgeons on these challenging techniques. Trainers generally consist of an enclosure and some type of barrier blocking direct observation of the interior of the enclosure where simulated organs or training platforms are located. In some cases, the barrier is configured to be pierced by surgical instruments in order to gain access to the interior in order to observe and perform mock procedures and exercises.

The barrier serves to simulate an abdominal wall. In some cases, apertures may be pre-formed in the barrier to provide the simplest form of laparoscopic trainer. Laparoscopic instruments including scopes are passed through the apertures, and a live feed of the interior of the enclosure is captured via a camera and viewed on an adjacent video monitor. The surgeon observes the procedure on the video monitor during the operation. While much skill can be gained using simple trainers, efforts are being made to increase the fidelity of surgical simulation. More advanced laparoscopy simulators use different materials to mimic the softness and pliability of the human abdominal wall. Previous versions have used layers of different types of flat foam sheets to simulate the look and feel of the different types of tissue present in the human abdominal wall. These sheets generally remain flat or are curved only in one direction while simulating an abdominal wall.

A simulated abdominal wall must be strong enough to withstand the same or similar forces encountered in real surgery including forces from penetration of the simulated abdominal wall with a surgical trocar. In order to withstand such forces, the abdominal wall is generally a smaller sized insert in a larger and rigid representation of the abdomen. A small simulated abdominal wall and a larger one require some type of support structure to prevent its collapse during use. Care must be given in selecting the type of support structure so as to not detract from the overall look and feel of the simulated abdominal wall, and to not interfere with practice procedures especially during trocar placement.

Generally, a simulated abdominal wall that is configured to be penetrable by a surgical trocar is flat or curved only in one direction. While easy to manufacture, these designs present an aesthetic shortcoming which greatly detracts from the realism of the simulation. Furthermore, in real laparoscopic procedures the interior of the abdomen is insufflated with gas and the patient's abdominal wall bows outwardly to have a convex surface that curves in multiple directions. While simulators do not use insufflation gas, it is desirable to represent the same curvature and working space created by insufflation. A simulated abdominal wall with a realistic curvature and also with anatomical landmarks such as ribs or cartilage greatly aids the trainee in learning proper port placement. Proper port placement allows safe access to the abdominal cavity, and adequate triangulation for accessing the key internal anatomical structures throughout a surgical procedure. The present invention presents a simulated abdominal wall suitable for laparoscopic trainers that provides a more lifelike simulation and is large enough to provide the user with a larger range of port placement. The present invention further presents methods to create a layered foam abdominal wall that is strong and does not require additional support structures to maintain its shape even during port placement. The simulated abdominal wall of the present invention also includes anatomical landmarks and has the visual appeal of a truly convex surface of an insufflated abdomen.

### SUMMARY OF THE INVENTION

According to one aspect of the invention, a simulated abdominal wall that has a convex shape mimicking the visual appearance of an insufflated human abdomen and requires no internal support structures to maintain the shape is provided. The simulated abdominal wall includes a multiple of laminated layers of foam connected together with adhesive. The multiple layers increases the overall rigidity of the structure which springs back to its original shape after being deformed and retains enough rigidity to allow realistic puncture by trocars. An outer skin layer comprising a silicone layer mechanically bonded to foam layer is also part of the layered structure. Methods of manufacturing and integrating the simulated abdominal wall with a laparoscopic trainer are also provided.

According to another aspect of the invention, a simulated abdominal wall is provided. The simulated abdominal wall is configured to permit the user to penetrate the simulated abdominal wall with a trocar anywhere through its surface without interference from unrealistic underlying and/or traversing support structures used for maintaining a bowed shape. The construction provides a realistic feel and is supported only around its perimeter without other support structures.

According to another aspect of the invention, a method for making a simulated abdominal wall is provided. The method includes providing a planar first layer of the simulated abdominal wall. A first three-dimensional domed shape is projected onto a planar two-dimensional surface of the first layer to create a first projection. The first projection is cut out of the first layer to create a first cutout having a first perimeter. A mold having a mold cavity is provided. The cavity has a cavity surface that is sized and configured to receive the first cutout. The first cutout is placed inside the mold cavity. Portions of the first perimeter are brought into juxtaposition to form the first domed shape in a loose fashion wherein the first domed shape has seams defined along the joined portions of the first perimeter. The first domed shape has an inner surface and an outer surface. A planar second layer of the simulated abdominal wall is provided. A second domed shape is projected onto a planar surface of the second layer to create a second projection. The second projection is cut from the second layer to create a second cutout having a second perimeter. The second cutout is placed inside the mold cavity. Portions of the second perimeter are brought into juxtaposition to form the second domed shape wherein the second domed shape has seams defined along the joined portions of the second perimeter. The second domed shape has an inner surface and an outer surface. The second domed shape is slightly smaller and placed inside the first domed shape such that the inner surface of the first domed shape faces the outer surface of the second domed shape.

According to another aspect of the invention, a method for making a simulated abdominal wall is provided. The method includes providing a mold having hemispherical-like cavity. A plurality of planar cutouts of domed projections is also provided. Each cutout is assembled into a dome having seams and nested consecutively inside each other inside the cavity. Adjacent cutouts are adhered to create a unitary simulated abdominal wall made of a plurality of layers and having a dome-like shape.

According to another aspect of the invention, a method for making a simulated abdominal wall is provided. The method includes providing a vacuum mold having a mold cavity formed by a main body of the mold. The main body of the mold defines a wall having an inner surface and an outer surface with a plurality of air holes extending across the wall in the location of the mold cavity. At least one flat foam sheet is provided and placed to cover the cavity. A pressure differential is applied across the wall through the air holes of the main body. Heat is also applied to the flat foam sheet. The flat foam sheet is deformed into a deformed layer having a deformed shape as a result of applying heat to soften the foam and the vacuum pulling the softened foam into the mold. The deformed shape substantially corresponds to the shape of the mold cavity or previous layer or layers.

According to another aspect of the invention, a surgical training system is provided. The surgical training system includes a base and a top cover connected to and spaced apart from the base to define an internal cavity. The top cover includes an opening and a frame connected to the top cover in the location of the opening. A penetrable simulated abdominal wall is connected to the frame and covers at least part of the opening. The simulated abdominal wall is dome-shaped having a convex surface and a concave surface facing the cavity.

### BRIEF DESCRIPTION OF THE DRAWINGS

FIG. 1 is a sectional side view of surgical instruments inserted via trocars to access simulated organs located inside a surgical simulator according to the present invention.

FIG. 2 illustrates a simulated abdominal wall that is curved in one direction.

FIG. 3 illustrates a simulated abdominal wall that is curved in two directions according to the present invention.

FIG. 4A illustrates a surface of a dome projected onto a flat surface according to the present invention.

FIG. 4B illustrates the surface of FIG. 4A with its edges joined together forming a dome according to the present invention.

FIG. 4C illustrates a surface of a dome projected onto a flat surface according to the present invention.

FIG. 4D illustrates the surface of FIG. 4C with its edges joined together, forming a dome according to the present invention.

FIG. 5 is a transparent view of a mold used for the layup method for forming a simulated abdominal wall according to the present invention.

FIG. 6A illustrates the domed projection cutout of FIG. 4C above and prior to placement into the layup mold of FIG. 5 according to the present invention.

FIG. 6B illustrates the domed projection cutout of FIG. 4C with its edges joined together inside the layup mold of FIG. 5 according to the present invention.

FIG. 6C illustrates the domed projection cutout of FIG. 4A above and prior to placement into the layup mold of FIG. 5 according to the present invention.

FIG. 6D illustrates the domed shape of FIG. 4B nested inside the domed shape of FIG. 4D inside the mold according to the present invention.

FIG. 7 is a sectional view of the layup mold of FIG. 5 with four foam layers according to the present invention.

FIG. 8 is a top perspective, exploded view of a negative cavity vacuum mold according to the present invention.

FIG. 9 is a top perspective, exploded, sectional view of a negative cavity vacuum mold according to the present invention.

FIG. 10 is a top perspective, sectional view of a negative cavity vacuum mold according to the present invention.

FIG. 11 is a top perspective, sectional view of vacuum mold and a flat undeformed foam layer according to the present invention.

FIG. 12A is a top perspective, sectional view of a vacuum mold and a flat, undeformed foam layer according to the present invention.

FIG. 12B is a top perspective, sectional view of a vacuum mold and a deformed layer according to the present invention.

FIG. 13 is an exploded, sectional view of a vacuum mold, a deformed layer and a flat undeformed layer according to the present invention.

FIG. 14A is a top perspective, sectional view of a vacuum mold, a deformed layer and a flat undeformed layer according to the present invention.

FIG. 14B is a top perspective, sectional view of a vacuum mold with two deformed layers according to the present invention.

FIG. 15 is an exploded, sectional view of a vacuum mold, a plurality of deformed layers and one undeformed layer according to the present invention.

FIG. 16A is a top perspective view of an undeformed layer in place on the vacuum mold and five previously deformed foam layers according to the present invention.

FIG. 16B is a top perspective view of six deformed layers and a vacuum mold according to the present invention.

FIG. 17A is a top perspective, exploded view of a vacuum mold, a deformed layer, an undeformed layer, and three bony inserts according to the present invention.

FIG. 17B is a top perspective view of a vacuum mold, a deformed layer, an undeformed layer, and a bony insert adhered to the deformed layer according to the present invention.

FIG. 17C is a top perspective, sectional view of a vacuum mold, at least one deformed layer, an undeformed layer, and a bony insert according to the present invention.

FIG. 17D is a detailed sectional view of a vacuum mold, and a bony insert located between two deformed layers according to the present invention.

FIG. 18 is a top perspective view of a flat piece of foam, and an uncured sheet of silicone prior to being joined to make a skin layer according to the present invention.

FIG. 19A is a top perspective view of a skin foam layer in place on an uncured layer of silicone according to the present invention.

FIG. 19B is a top perspective view of a skin foam layer connected to a cured layer of silicone trimmed of excess cured silicone according to the present invention.

FIG. 20 is an exploded view of the vacuum mold, an undeformed skin layer, previously deformed layers and a weighted plug used to join the previously deformed layers to the skin layer according to the present invention.

FIG. 21A is an exploded view of an undeformed skin layer in place on a vacuum mold, previously deformed layers and a weighted plug according to the present invention.

FIG. 21B is a top perspective view of a deformed skin layer, previously deformed layers and a weighted plug ready to be placed on top according to the present invention.

FIG. 21C is a top perspective view of a deformed skin layer shows the skin layer in place on the vacuum mold after forming, with previously deformed foam layers in place, and a weighted plug ready to be placed inside the cavity according to the present invention.

FIG. 21D is a top perspective view of a deformed skin layer inside a vacuum mold, with the deformed foam layers and weighted plug in place inside the cavity of a vacuum mold according to the present invention.

FIG. 22 is a top perspective view of a simulated abdominal wall for use in the assembly of the trainer according to the present invention.

FIG. 23 is a top perspective view of a final simulated abdominal wall fit into the simulated abdominal wall frame according to the present invention.

FIG. 24 is an exploded view of a simulated abdominal wall and two frame halves according to the present invention.

FIG. 25 is a partial cross-sectional view of an angled channel of the two frame halves and simulated abdominal wall compressed therebetween according to the present invention.

FIG. 26A is a sectional view of a bottom frame half with retention protrusions according to the present invention.

FIG. 26B is a sectional view of simulated abdominal wall and frame according to the present invention.

### DETAILED DESCRIPTION OF THE INVENTION

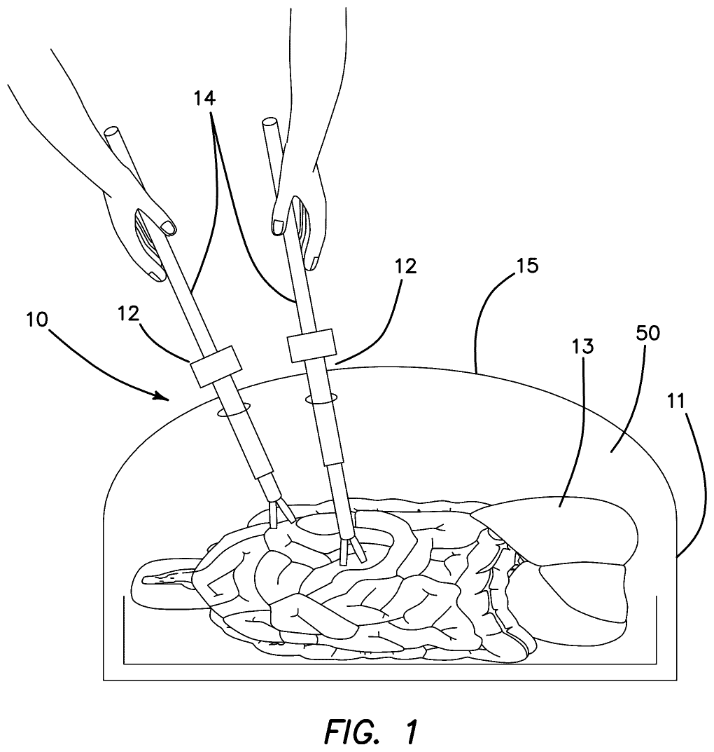

With reference to FIG. 1, a surgical simulator for laparoscopic procedures, also known as a trainer, 10 is provided. The trainer 10 allows a trainee to practice intricate surgical maneuvers in an environment that is safe and inexpensive. The trainer 10 generally consists of an enclosure 11 comprising an illuminated environment that defines an interior cavity 50. The interior cavity 50 is accessed with surgical access devices such as trocars 12. The enclosure 11 is sized and configured to replicate a surgical environment. For example, the trainer 10 is configured as a portion of a human abdomen and, in particular, configured to appear to be an insufflated abdominal cavity. Simulated organs 13 may be provided inside the enclosure 11. The simulated organs 13 are capable of being manipulated and “operated on” in mock procedures using real surgical instruments 14, such as but not limited to graspers, dissectors, scissors and even energy-based fusion and cutting devices. Instead of simulated organs 13, the enclosure 11 may be provided with an exercise platform configured for practicing one or more techniques in isolation. For example, a suture board, instead of simulated organs 13, may be located inside the enclosure 11 for the purpose of practicing suturing techniques.

The trainer 10 further includes a simulated abdominal wall 15. The simulated abdominal wall 15 generally covers the top of the trainer 10 through which trocars 12 are placed. The simulated abdominal wall 15 is connected to sidewalls of the trainer 10 or other frame structure that connects to the trainer 10. The simulated abdominal wall 15 is curved in a manner to improve the realism of the simulation. In one variation, this curvature mimics an insufflated abdominal wall. The simulated abdominal wall 15 is further configured to provide a plurality of layers including but not limited to layers designed to represent skin, muscle, fat, bone, cartilage, and peritoneum. The simulated abdominal wall 15 is further configured to provide a realistic visual via a scope inside a trocar during penetration and, thereby, include all of the layers, characteristic colors, thickness and anatomical landmarks to realistically inform the surgeon of the progression through the layers and, thereby, teach prevention of accidental organ puncture. The simulated abdominal 15 wall must provide not only, a realistic visual, but also, a realistic tactile sensation that includes realistic force levels of the instruments through the simulated abdominal wall 15.

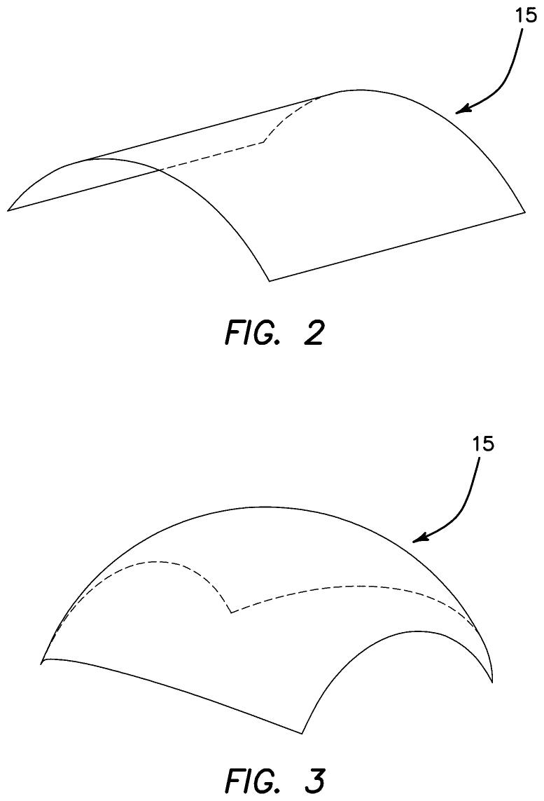

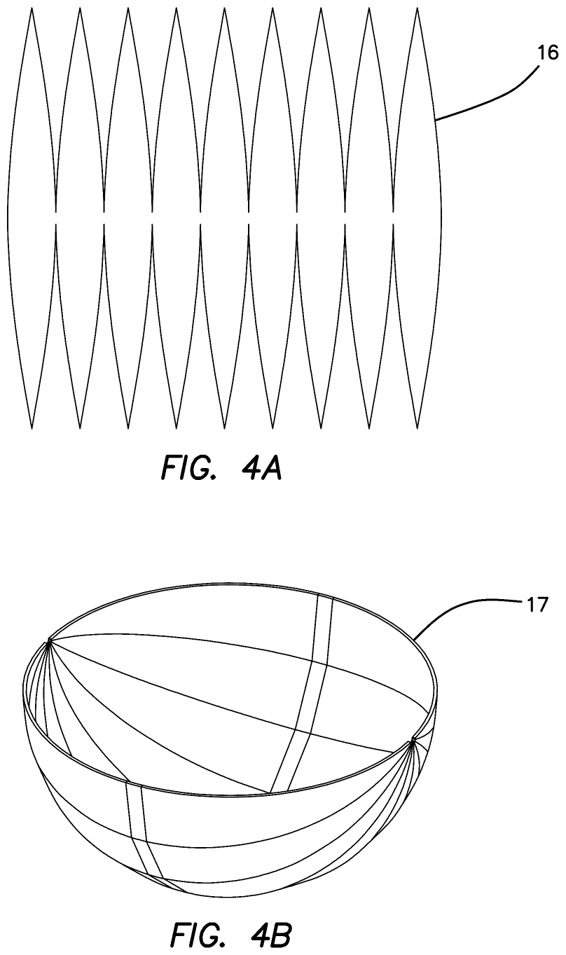

Turning to FIG. 2, an exemplary surface of a simulated abdominal wall 15 curved in one direction is shown. The partial cylinder of the simulated abdominal wall 15 is easy to manufacture and many of the prior trainers 10 make use of such a simulated abdominal wall 15 that has a curvature about a single axis only. This shape is an approximation of the real shape of an insufflated abdomen. Additionally, the shape of FIG. 2 is not as structurally sound as a shape that curves in two directions; therefore, abdominal wall designs that are curved in this way often necessitate the use of additional internal support structures. FIG. 3 shows a simulated abdominal wall 15 surface that curves in two directions. The partially spherical surface of FIG. 3 is both more lifelike, and also more structurally sound than a simulated abdominal wall surface that curves in only one direction. The simulated abdominal wall of the present invention eliminates the need for internal support structures while creating a shape that has a visual look and tactile feel that more closely mimic the real abdominal wall.

A method for manufacturing a simulated abdominal wall is provided. The method includes the step of projecting a domed, three-dimensional shape of the desired curvature onto a flat surface of a foam layer. The projection is cut out of the foam layer. Then the three-dimensional surface of a dome is formed from the projected two-dimensional surface of a cutout by bringing the edges of each cutout together forming seams in a prescribed manner. Each cutout represents one or more anatomical layers of a human abdominal wall. In the method, a plurality of cutouts, each sequentially slightly smaller are nested inside each other to build up a complete domed abdominal wall structure. The layers are held in position inside a mold having a conforming depression and laminating together with the adhesive.

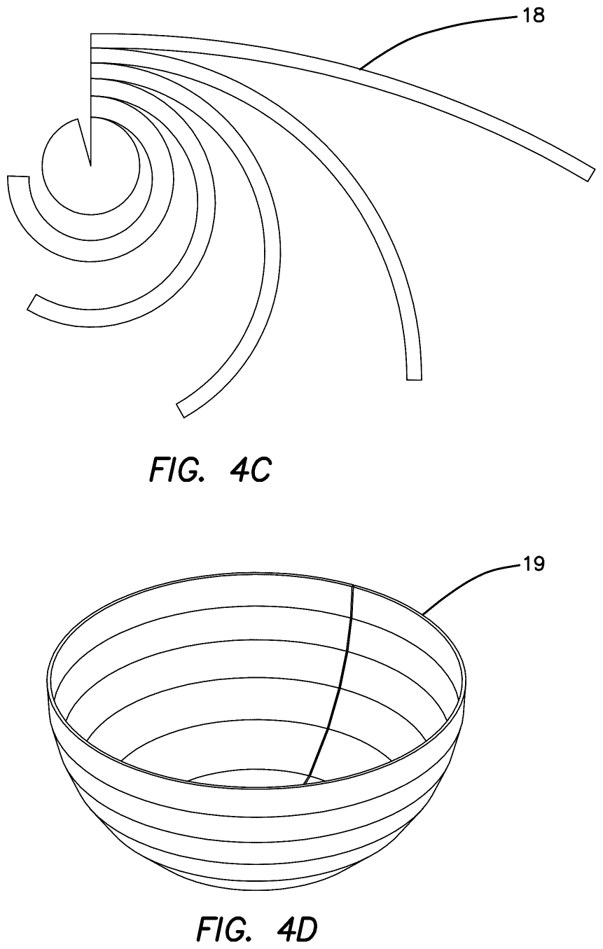

Turning to FIG. 4A, a cutout of a domed projection 16 is shown. The cutout 16 is a transformation of the latitudes and longitudes of locations from the surface of a dome into locations on a plane. The same projection 16 with its edges brought together in order to form a domelike shape 17 is shown in FIG. 4B. Similarly, FIG. 4C shows a cutout of an alternate domed projection 18. The same projection 18 with its edges brought together to form a hemisphere-like shape 19 is shown in FIG. 4D. One skilled in the art can contemplate different types of cutout projections having different patterns than the ones shown in FIGS. 4A-4D. Also, the invention is not limited to hemispherical projections. Other domed shapes may also be projected. For example, an ellipsoid or any curved surface may be projected in the present invention. The projections serve either as a layer or pattern for cutting sheets to form one or more domed layers that are to constitute the simulated wall of the present invention as will be described in greater detail below.

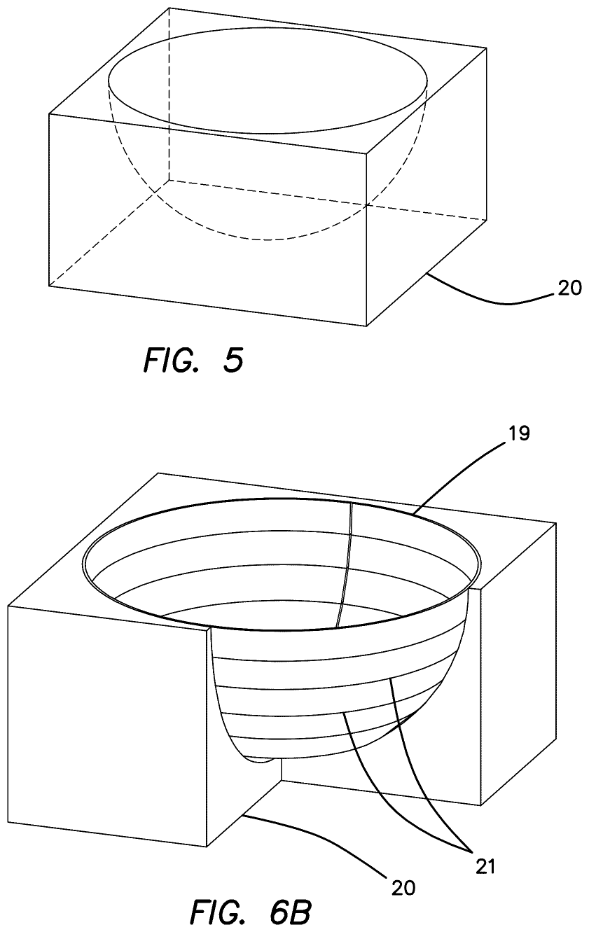

FIG. 5 shows a simple layup mold 20 that is used to form the layered simulated abdominal wall 15 according to the present invention. The mold 20 includes a hemispherical depression sized and configured for the desired shape of the final simulated abdominal wall 15. The depression may be semi-ellipsoidal, domed or curved in shape in another variation. The mold 20 is sized and configured to receive the cutout projections when layering them up to form a multiplicity of layers glued together into a multi-layered simulated abdominal wall 15. The layers are made of foam such as polyurethane foam, ethylene-vinyl acetate (EVA) foam, polyethylene foam, open cell foam, memory foam or silicone or a combination of silicone and foam. The polyurethane foam has a density of approximately 6 pound per cubic foot.

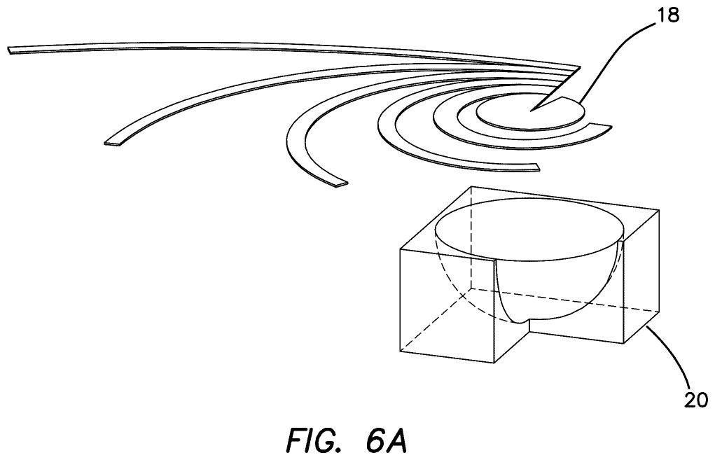

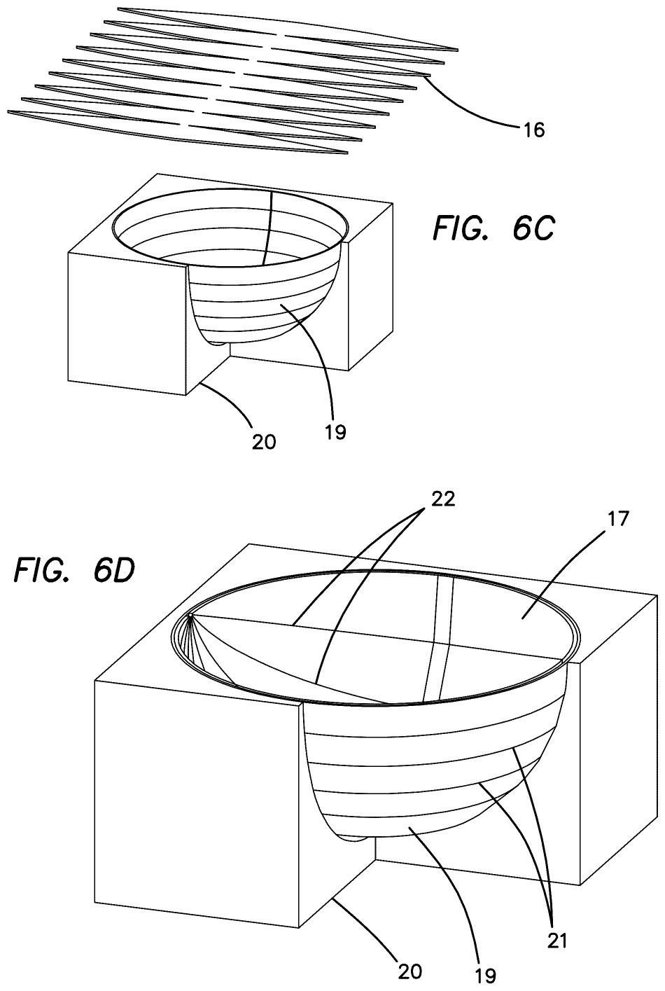

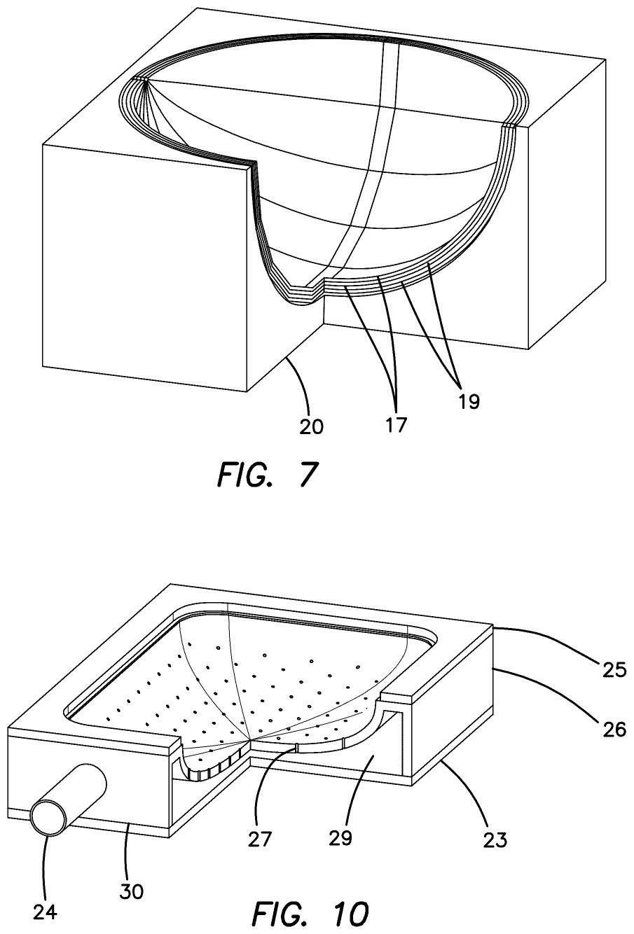

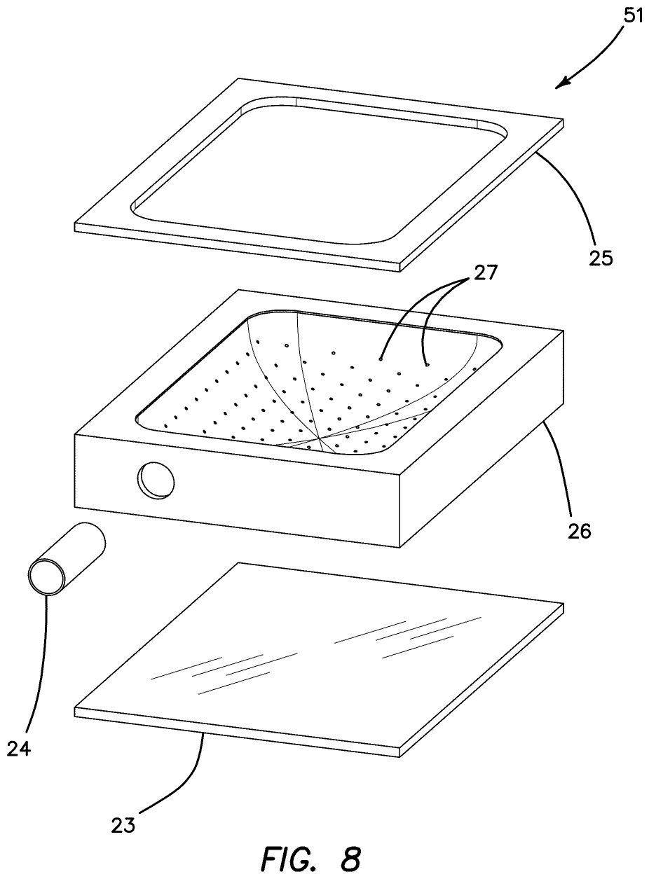

The size and shape of the depression of the mold conform closely to the shape of the assembled cutout projections. A cutout projection is assembled when its edges are joined together to form the desired shape. For example, in FIGS. 6A-6B, it can be seen that the cutout 18 fits into the depression of layup mold 20, thus forming a hemisphere-like shape 19. When the cutout 18 is located inside the mold 20, the edges of the cutout 18 are in juxtaposition to form seams 21 having a latitudinal orientation. FIG. 6C illustrates the cutout 16 in a flat orientation adjacent to the layup mold 20 containing the other cutout 18. Turning now to FIG. 6D, cutout 16 is shown located inside the depression of mold 20 with its edges together and nested inside the other cutout 18 previously placed into the mold 20. Again, note the latitudinal orientation of seams 21 of cutout 18 forming dome 19 and compare to the longitudinal orientation of seams 22 of cutout 16 forming dome 17. FIG. 6D is a two-layered simulated abdominal wall 15. The number of layers may be increased in a similar manner as described by alternating the two or more curved surfaces 17 and 19 to build up the layers of the simulated abdominal wall such that their seams do not align.

FIG. 7 illustrates a section view of mold 20 with alternating domes 17 and 19 located in the mold 20. Each successive dome is sized to be slightly smaller to account for the thickness of each prior foam layer. Also, in one variation, each added dome alternates between at least two or more different cutout projections, lest the seams line up through the foam layers, which would result in a foam piece with reduced or no structural integrity. Alternatively, the same cutout projection may be employed for each layer such that each subsequent layer is rotated/displaced slightly to avoid alignment of the seams with the seams of the previous layer. For example, the cutout projection 16 of FIG. 4A can be rotated inside the mold 20 relative to the previously placed cutout projection 16 such that the seams 22 are offset and not aligned. It should be noted that different types and colors of foam sheets may be used to simulate the look of the layers present in a human abdominal wall. Adhesive is applied between the cutout projections to adhere the layers to form the abdominal wall.

By cutting flat sheets in a pattern and forming a three-dimensional dome from the combined flat sheets as described above, a resilient convex surface is created. Furthermore, because adhesive is applied only on the large flat surfaces of the foam and not directly to the thickness of the seams, there are no areas in the simulated abdominal wall where the stiffness is greater than the surrounding areas due to a thick seam of glue. Once all of the desired underlying layers have been laminated together, a foam/silicone skin layer is stretched and adhered to the work-piece. The skin layer covers up all of the seams, leaving a smooth convex surface visible to the user. The foam/silicone skin layer will be described in greater detail below.

In another method, a vacuum mold is used to form flat foam sheets into convex foam sheets and join them together. In this method, a flat foam sheet is placed on the vacuum mold and held in place with a frame. The vacuum pump is then turned on, and heat is applied to the foam. The heat relaxes the foam, allowing it to yield and stretch into the mold cavity due to the suction of the vacuum. Spray adhesive is applied to the foam in the mold and to a new sheet of foam. Next, a multitude of holes are poked through the first layer of foam so that the vacuum can act on the second layer of foam through the first. The order of hole-poking and glue application can be reversed and the process will still work. The frame is removed, the next sheet of foam is placed glue side down onto the vacuum mold with the first foam layer still in place, glue side up, and the frame is replaced. Again, the vacuum pump is turned on and heat is applied to the top foam layer. As the two foam layers come into contact they are bonded together. This process is then repeated for each desired foam layer. With the addition of each foam layer, the simulated abdominal wall gains strength. Once the desired foam layer configuration is met, the simulated abdominal wall is then inserted into an abdominal wall frame, which is a two piece component that secures the simulated abdominal wall along the perimeter only by compressing it between top and bottom frame parts and allows the user to easily install and take off the wall/frame assembly from the surgical simulator enclosure. The geometry of the abdominal wall frame adds further support to the convex form and feel of the simulated abdominal wall by utilizing an angled channel along the perimeter that the simulated abdominal wall is compressed between. The method will be described in greater detail with reference to the drawings hereinbelow.

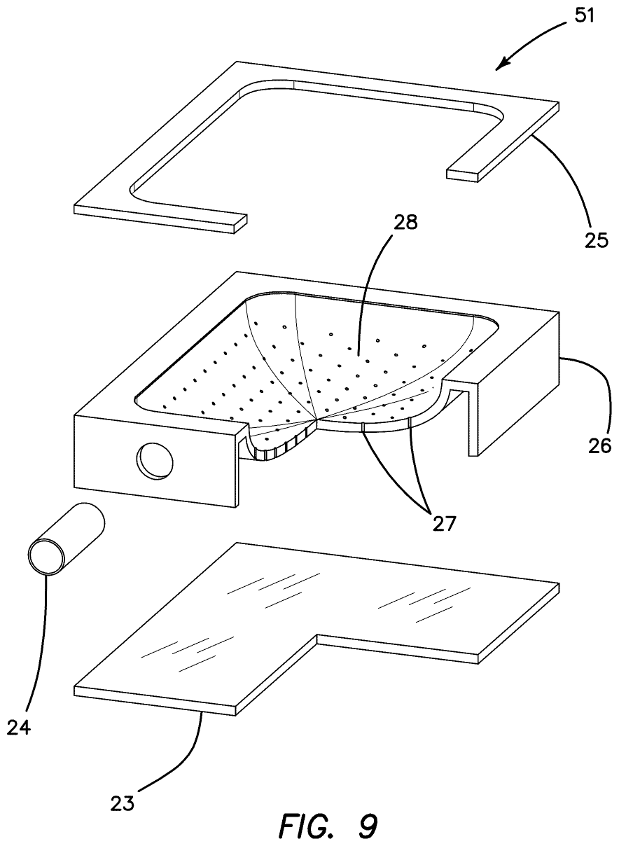

Turning now to FIG. 8, an exploded view of a negative cavity vacuum mold 51 is shown. The vacuum mold 51 includes a base 23, air outlet 24, frame 25, and main body 26 having a negative cavity 28. FIG. 9 shows an exploded sectional view of the same vacuum mold 51. In this view, air holes 27 are seen to pierce the cavity 28. FIG. 10 shows a collapsed, sectional view of the vacuum mold 51 showing the plenum 29 created between the base 23 and main body 26, the plenum 29 is sealed between the base 23 and main body 26, as well as between the main body 26 and frame 25 and in fluid communication with the air outlet 24.

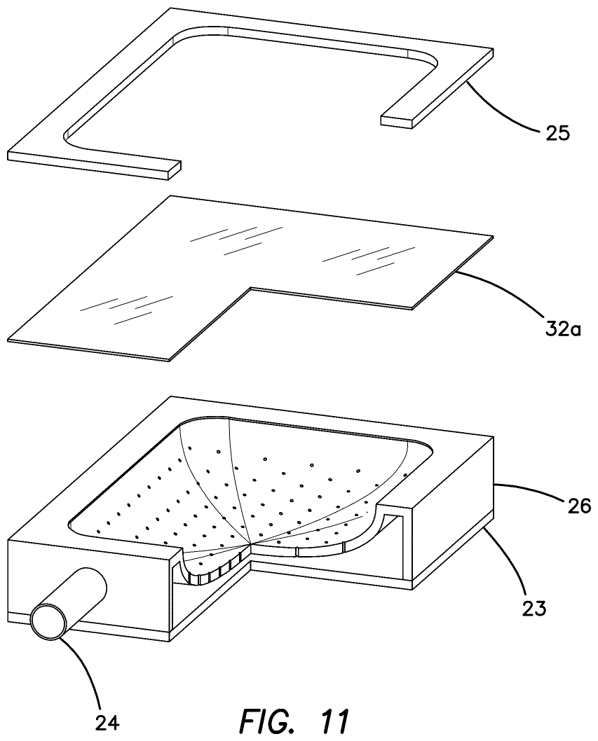

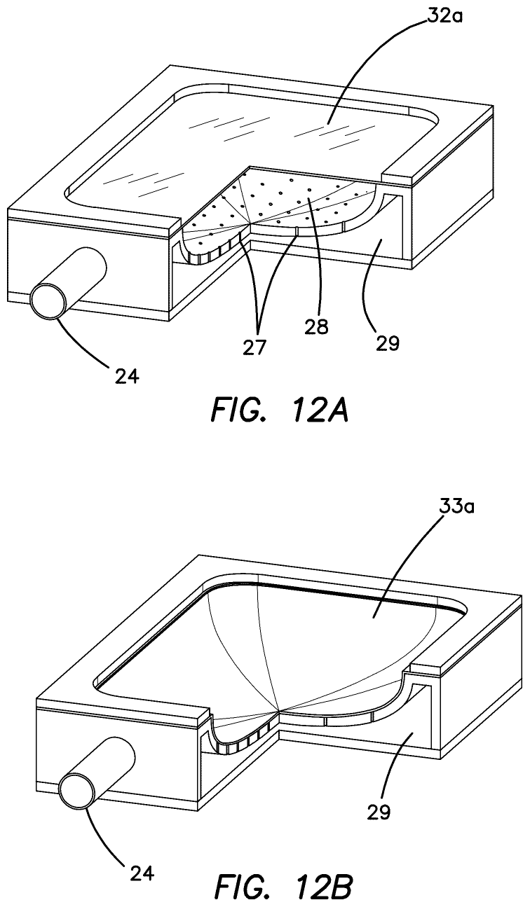

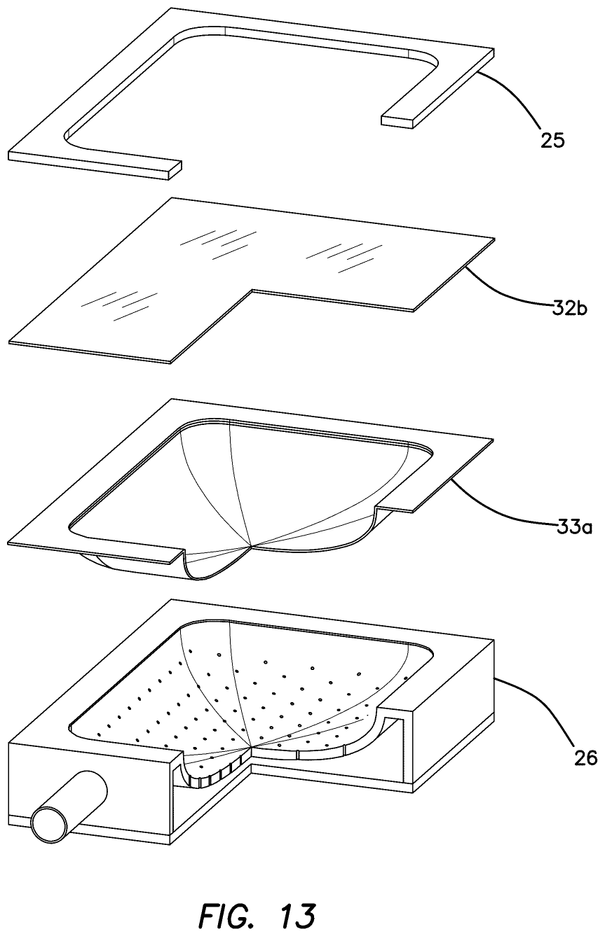

With reference now to FIG. 11, a first flat sheet 32a of foam material is located above the main body 26 of the vacuum mold 51 and underneath the frame 25 which keeps the flat sheet 32a in place with respect to the mold 51. FIG. 12A shows the flat foam sheet 32 prior to forming. During the forming process, air is evacuated through air outlet 24, which creates negative pressure in the plenum 29. This negative pressure acts through air holes 27, and sucks the flat foam sheet 32 towards the inner surface of the cavity 28. While air is being evacuated through outlet 24, heat is applied, such as with a hot air gun or integrated heating element, to the top of the foam sheet 32. The heat allows the foam sheet 32 to stretch and conform to the shape of the cavity 28 making complete contact with the surface of the cavity 28. The heat is generally applied simultaneously with the application of vacuum to the sheet; although the invention is not so limited and heat may be applied prior to vacuum. A deformed foam sheet 33a molded in the vacuum mold 51 is shown in FIG. 12B.

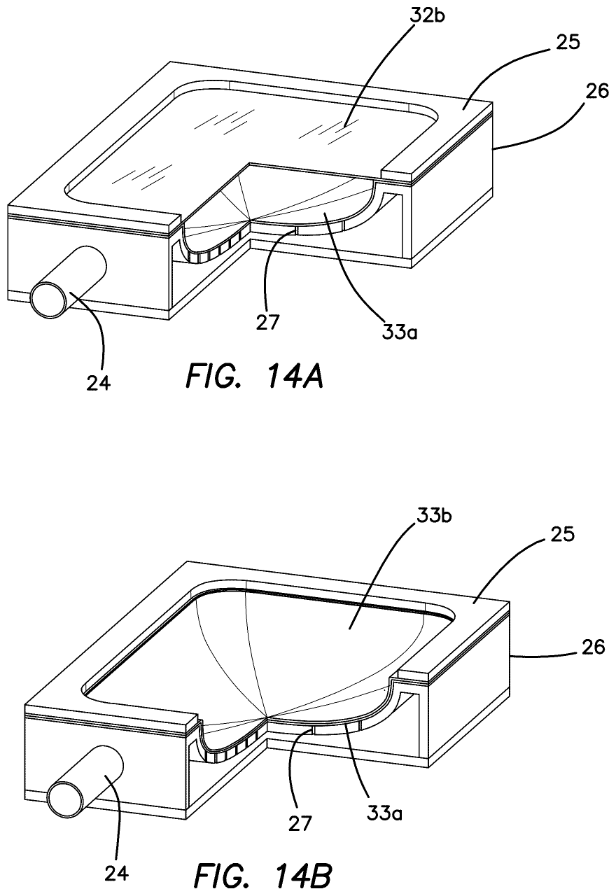

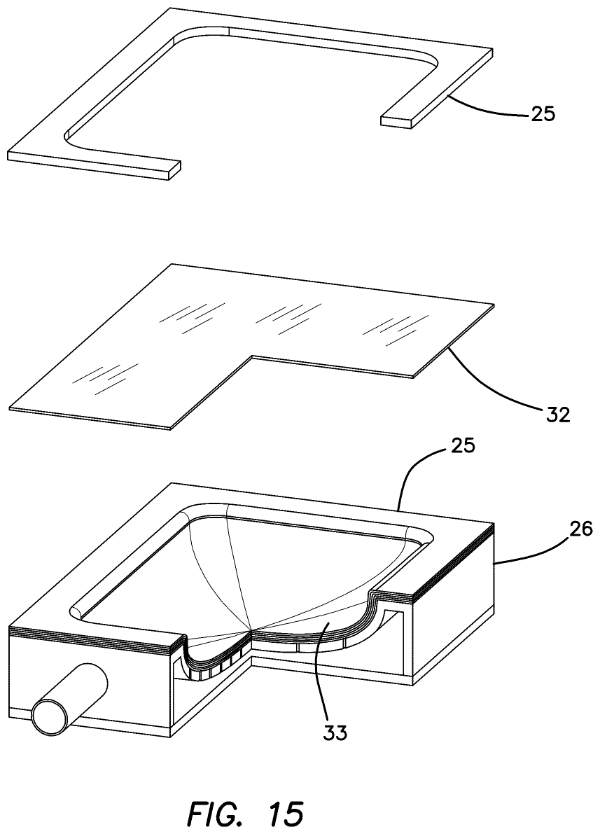

With reference now to FIGS. 13 and 14A, the frame 25 is lifted and a second flat undeformed sheet 32b is placed atop the main body 26 and underneath the frame 25 of the vacuum mold 51. Prior to placement of the second undeformed sheet 32b into the vacuum mold 51, a multitude of holes are poked through the previously formed first layer 33a to allow the suction to act through its thickness, thus pulling the second undeformed, flat sheet 32b into the cavity 28. The holes are poked with a cylindrical roller having a plurality of spikes. The spikes are long enough to penetrate the thickest layer and are approximately 0.75 inches long. The radius of the cylinder of the roller is approximately 1.25 inches. Thereby, the roller is large enough with spikes spread apart from each other to avoid tearing the foam. Also, the roller is small enough so that it can still perforate the areas of the foam in the cavity with a minimum radius of curvature of approximately 1.7 inches which is approximately the same radius of curvature of the abdominal wall in one variation. The holes are approximately 2 millimeters in diameter. The second flat sheet 32b is also made of foam. Prior to placement in the vacuum mold 51, adhesive is applied to the top side of the first formed foam layer 33a to adhere the two adjacent layers to each other. Adhesive may also be applied to the underside surface of the second undeformed flat sheet 32b that faces the first foam layer 33a to adhere the layers to each other. Contact cement including solvent-based or water-based contact adhesive, which stays soft and flexible, may be employed so that the adhesive does not interfere with the look and feel of the final product. Also, the adhesive is selected and carefully applied so as to not create too much drag when a trocar is pushed through the skin layer. FIG. 14B shows the second flat sheet simultaneously formed and adhered to the first formed foam sheet 33a. The intermediate result is a simulated abdominal wall 15 having two formed layers 33a, 33b glued together. The process can be repeated to build up a simulated abdominal wall having as many layers as desired. Again, different types and colors of foam, such as any flexible thermoplastic foam, may be used for each layer to simulate the colors and textures present in a real abdominal wall. For example, red and white layers can be made of ethylene-vinyl acetate having a density of approximately 2-4 pounds per cubic foot, pink and translucent layers can be made of closed-cell polyethylene.

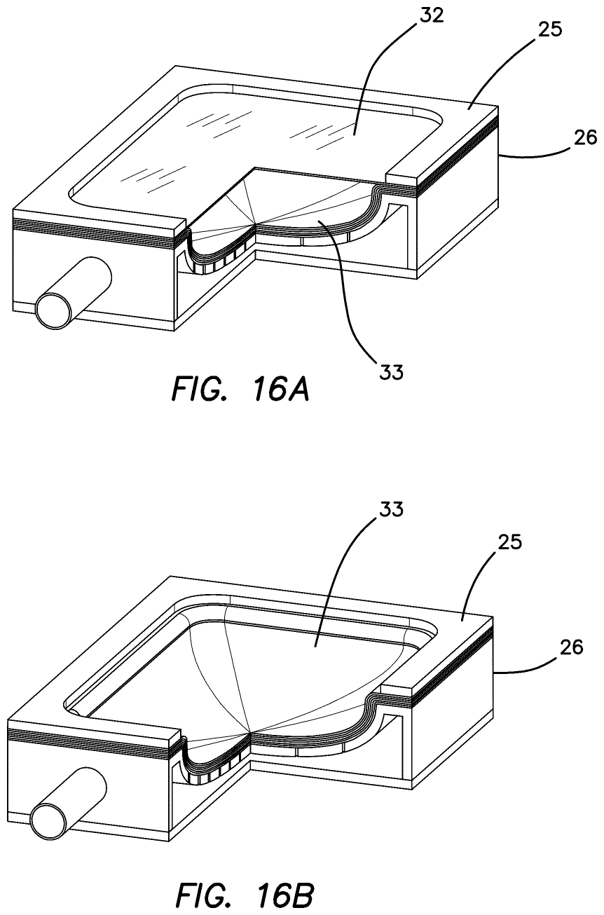

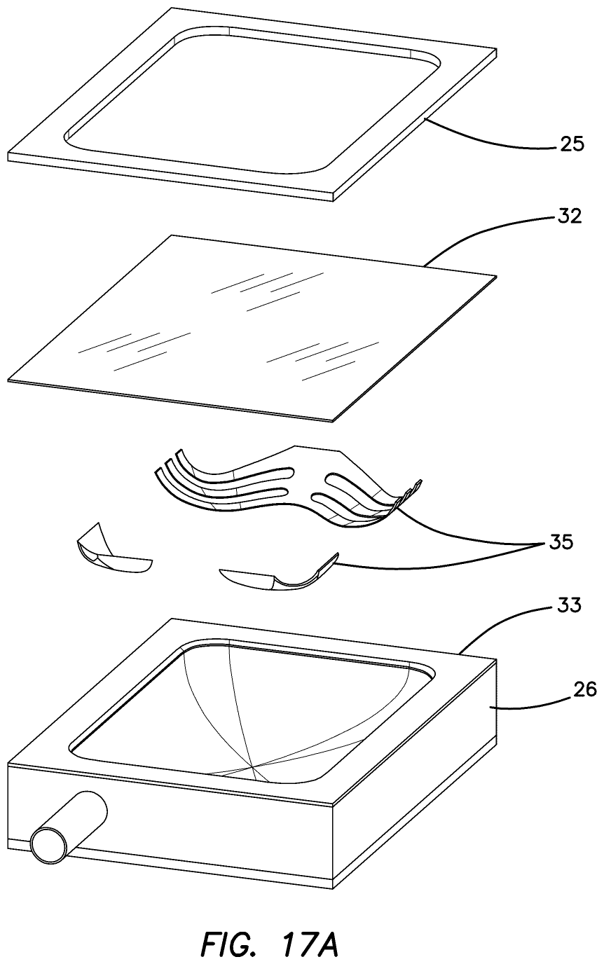

FIG. 15 illustrates the process described above after several repetitions wherein a flat foam sheet 32 is placed atop a plurality of previously deformed layers 33 and pressed against the pre-made foam layers 33 using the frame 25. FIGS. 16A and 16B show an undeformed layer prior to and after vacuum molding. Again, between adding layers, a multitude of small holes through the deformed foam layers 33 is provided to place the undeformed layer in fluid communication with the vacuum across the main body 26 and across the previously deformed layers 33. Adhesive is applied to the top of the previously deformed layers 33 and to the underside of the flat undeformed foam layer 32. When the vacuum is activated and the heat applied the undeformed layer will be simultaneously deformed and adhered to the previously deformed layer.

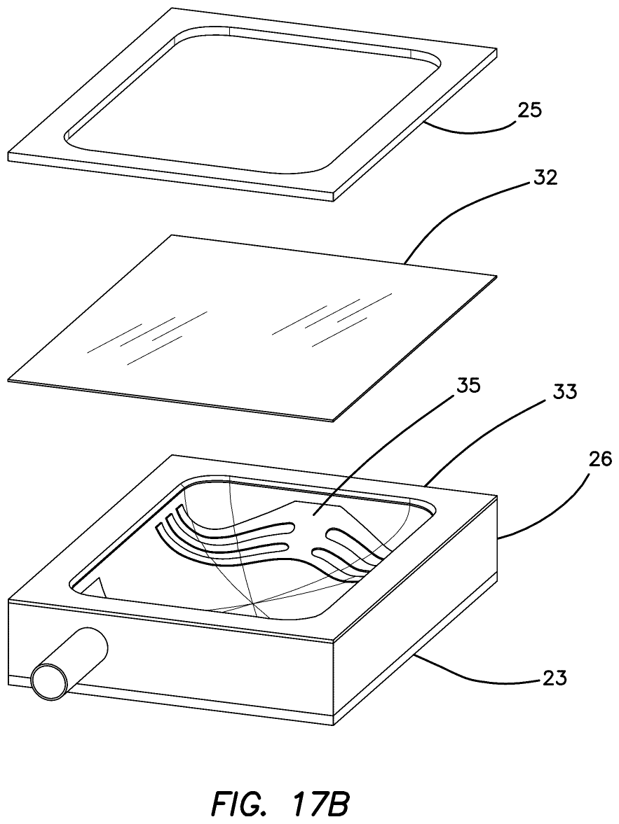

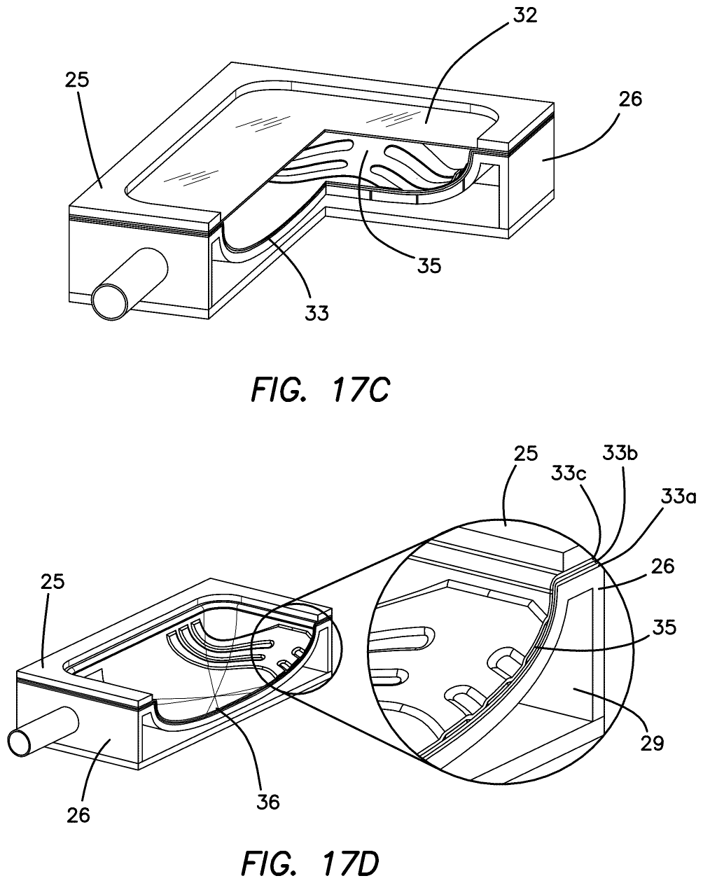

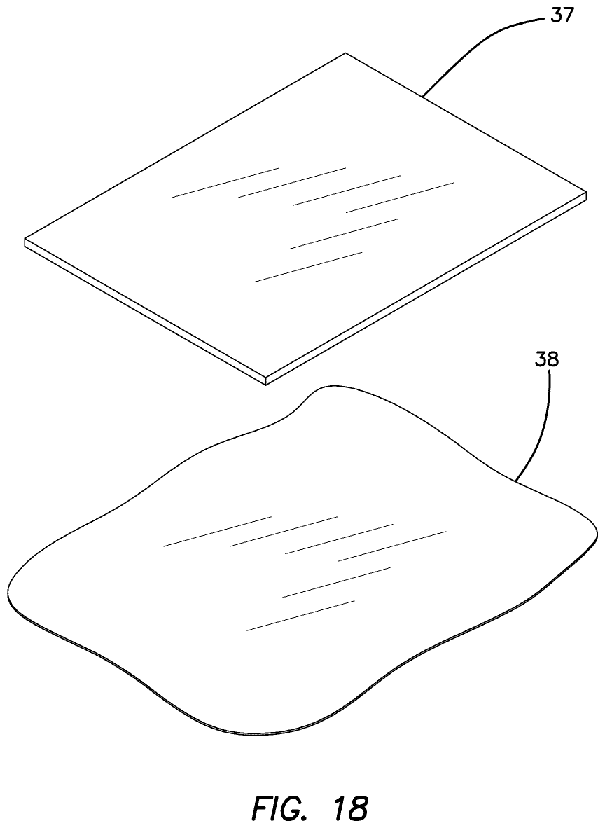

In one variation of this process, at least one insert 35 is provided between two layers as can be seen in FIGS. 17A-17D. At least one foam layer 33 has already been deformed by the vacuum mold and is located inside the cavity 28. Prior to placing a flat foam sheet 32 and frame 25 onto at least one previously deformed foam layer 33, at least one bony insert 35 is glued in place on the upper surface of the last deformed foam layer 33b. FIG. 17B shows the bony insert 35 glued in place on top of the pre-made foam layers 33. Adhesive is also applied to the top side of the bony insert 35, and a subsequent flat foam sheet 32 is placed on top and held in place with frame 25 as shown in FIG. 17C. FIG. 17D shows the bony insert 35 sandwiched and enclosed between two deformed layers 33b and 33c creating a simulated abdominal wall with a bony insert. Other adjacent layers 33 may include bone inserts 35 therebetween. Although the word “bony” is used, the invention is not so limited and bony inserts not only represent bone in the anatomy, but may represent any other anatomical structure of increased rigidity relative to the foam layers such as cartilage, muscle, bones, tumors and the like or of decreased rigidity relative to the layers such as blood vessels, nerves and the like. To replicate bone, the bony inserts 35 are made of rigid plastic. To replicate nerves or vessels, the bony inserts 35 may be made of soft silicone. The inserts may be made from but not limited to the following materials: polypropylene, styrene, polyethylene, nylon, paper, cardstock, polyvinyl chloride, polyethylene terephthalate, polyethylene, terephthalate glycol-modified, and acetal homopolymer resin.

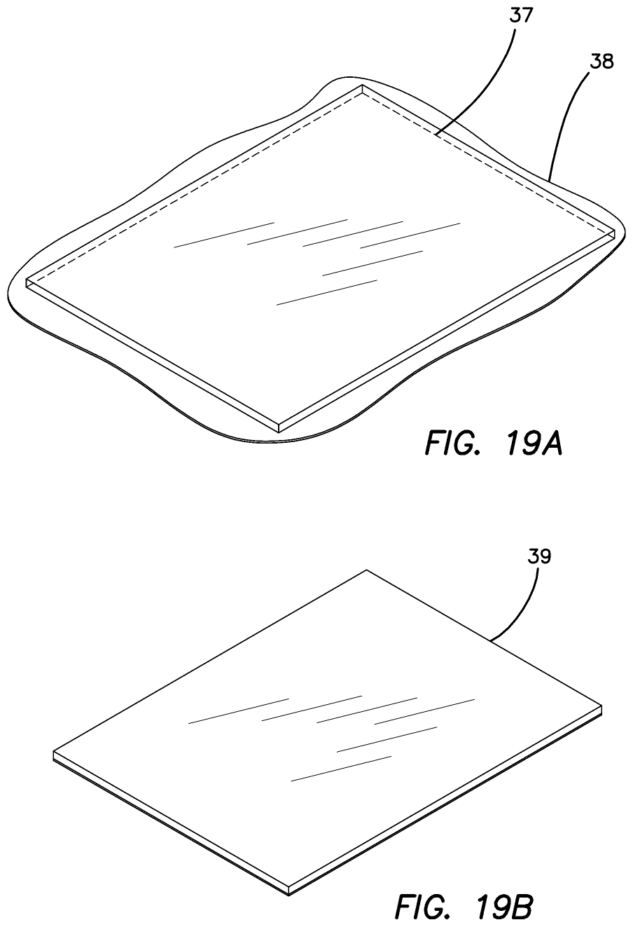

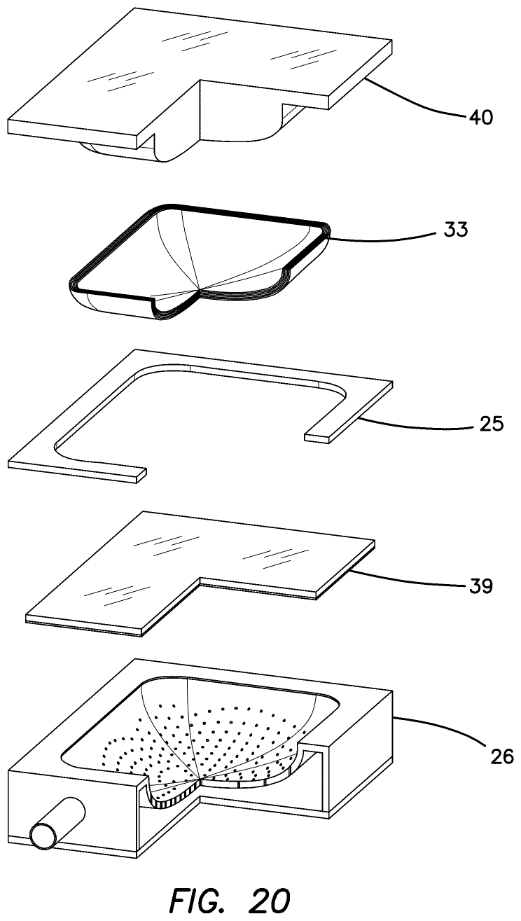

Turning now to FIG. 18, forming an outer skin layer 39 will now be described. The skin layer includes a skin foam layer 37 and a silicone layer 38. In one variation, the skin foam layer 37 is made of memory foam. In making the skin layer, the foam layer 37 is placed on an uncured silicone layer 38 as shown in FIG. 19A and the silicone layer 38 is allowed to cure. When the silicone cures on the foam, it creates a mechanical bond with the slightly porous foam material. As the silicone cures, it interlocks with the pores of the foam material. Once the silicone is fully cured, the excess is trimmed resulting in the trimmed skin layer 39. Because the silicone is securely bonded to the underlying foam, a much more durable skin layer is realized, and costs are driven down by reducing the frequency of abdominal wall replacement. The combination of foam and silicone closely adhered together via the curing process makes both layers easily deformed in the vacuum mold and further easily adhered to the rest of the deformed layers. Furthermore, in previous versions where the outer skin layer is not bound to the underlying layers, unrealistic spaces open up between the simulated abdominal wall layers during port placement visible to the surgeon. The present invention eliminates this issue because the silicone is mechanically bonded to a foam layer which is easily deformed and adhered to other foam layers.

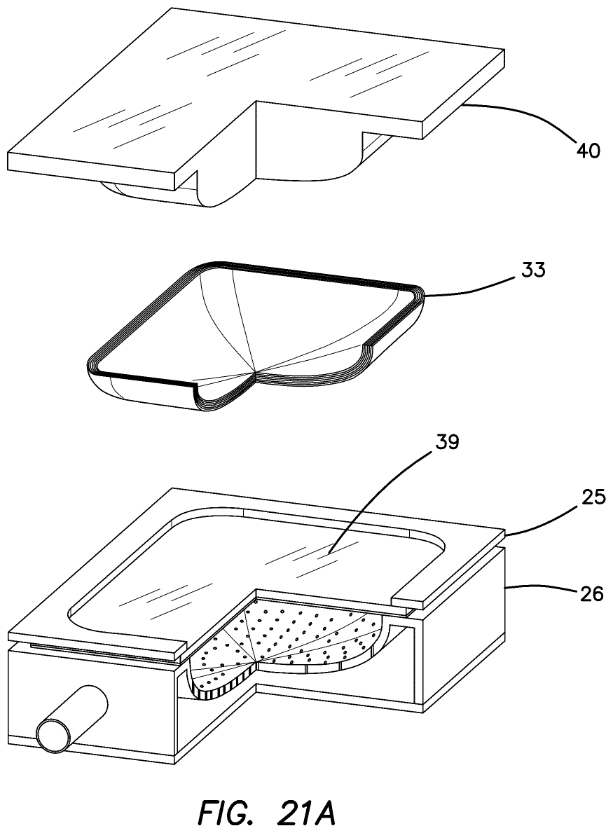

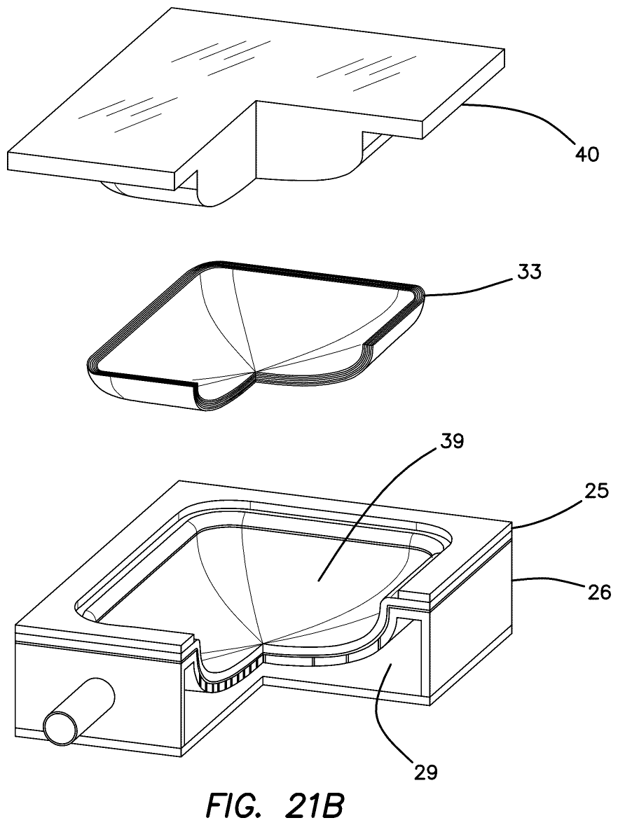

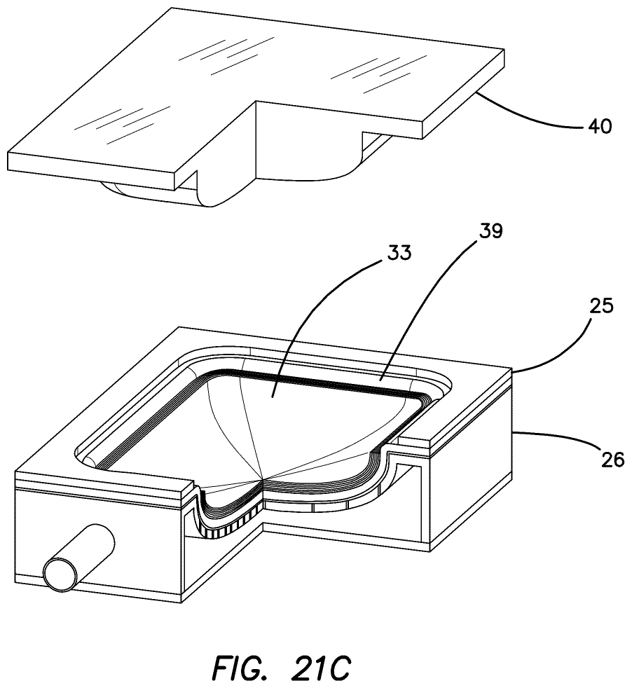

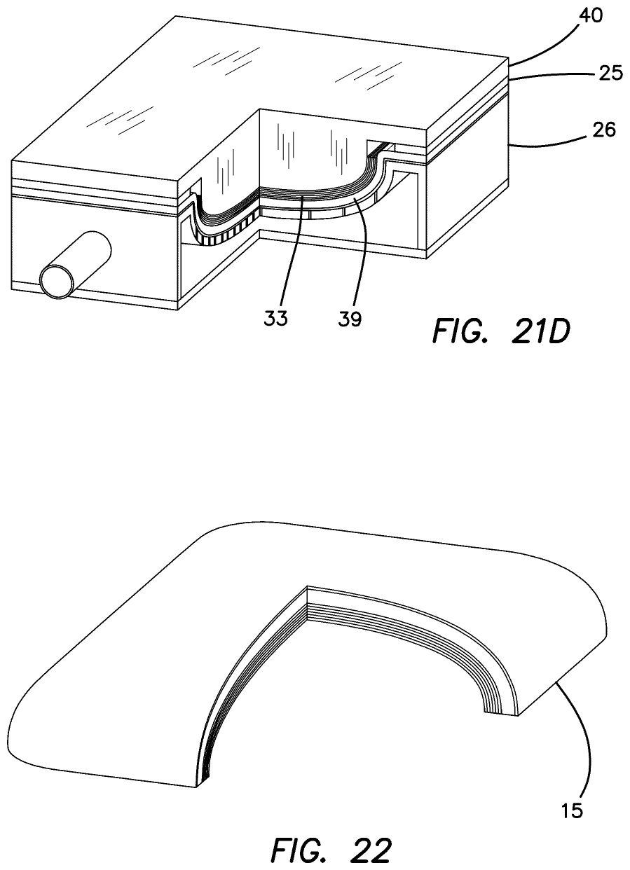

Turning now to FIGS. 20-21, after the skin layer 39 is prepared, it is placed inside the cavity 28 of the vacuum mold 20 followed by the frame 25. The trimmed skin layer 39 is positioned with the silicone skin layer 38 facing the main body 26 of the mold 20. FIG. 21A shows the trimmed skin layer 39 held in place on the vacuum mold's main body 26 by the frame 25 prior to evacuation of the vacuum mold. FIG. 21B shows the trimmed skin layer 39 pulled into the cavity 28 of the vacuum mold as a result of activation of a vacuum inside the plenum 29. In FIG. 21B, the previously deformed foam layers 33 with or without bony inserts 35 are ready to be pressed down into the cavity by the weighted plug 40. FIG. 21C shows the previously deformed foam layers 33 glued into a unitary body placed into the cavity 28 on top of the trimmed and deformed skin layer 39. Adhesive is added between the skin layer 39 and uppermost foam layer 33 to adhere the skin layer 39 to the rest of the deformed layers 33. FIG. 21D shows the placement of the weighted plug 40 on top of the previously deformed foam layers 33. The weighted plug 40 helps to press all of the layers together to uniformly adhere the different layers until the glue dries. FIG. 22 shows the final simulated abdominal wall 15 in its finished state prior to having its edges bound into a trainer 10 by a frame having top and bottom halves 43, 44 as will be described hereinbelow. The final simulated abdominal wall 15 has a polygonal footprint. The simulated skin layer 39 may also be employed in a similar manner with the variation of FIGS. 4-7 wherein the completed domed-shaped skin layer 39 is adhered to the one or more domed cutout layer wherein the domed cutout layer(s) may themselves be bonded together.

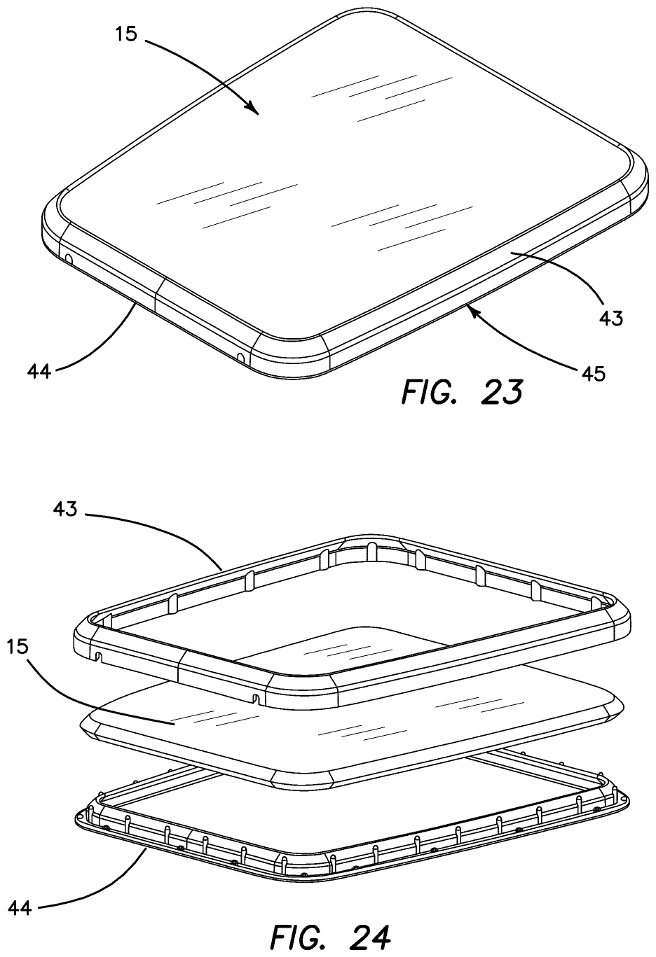

With reference to FIGS. 23-26, the simulated abdominal wall 15 is inserted into a simulated abdominal wall frame 45 which is a two-piece system including a top half 43 and a bottom half 44 that secures the simulated abdominal wall from the perimeter only by compressing the foam layers. The framed abdominal wall 15 is then removably fixed into a laparoscopic trainer 10. FIG. 24 shows the exploded view of the simulated abdominal wall 15 and frame assembly 43, 44 comprised of the simulated abdominal wall 15, top frame 43, and bottom frame 44. The top frame 43 and bottom frame 44 can be assembled together via screws or other fastener such as a snap-fit engagement in the case of a re-usable frame system, or snapped together via heat staking or other low cost assembly method.

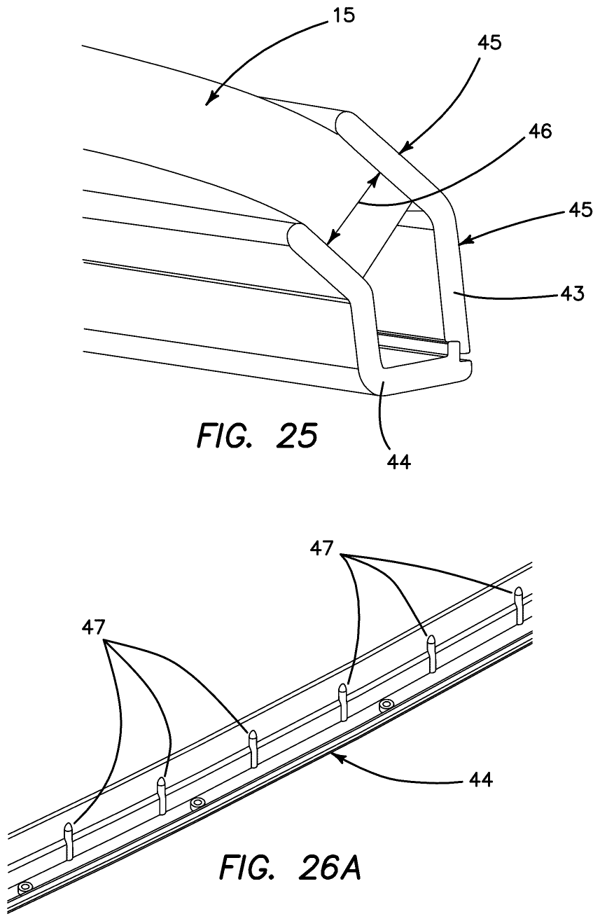

With reference to FIG. 25, the simulated abdominal wall frame 45 includes an angled channel 46 in which the simulated abdominal wall 15 is compressed to secure it into the frame 45. The angled channel 46 is created by the top and bottom frame components 43, 44. If the simulated abdominal wall 15 was compressed between two flat frames, it would weaken the structure and it would invert/collapse during use much more easily. The channel 46 is angled from the vertical axis toward the middle of the simulated abdominal wall 15. This angle follows the contour of the convex form of the simulated abdominal wall 15 and significantly strengthens and increases the support provided to the convex form of the simulated abdominal wall 15. Without this feature the simulated abdominal wall would invert during use much more easily.

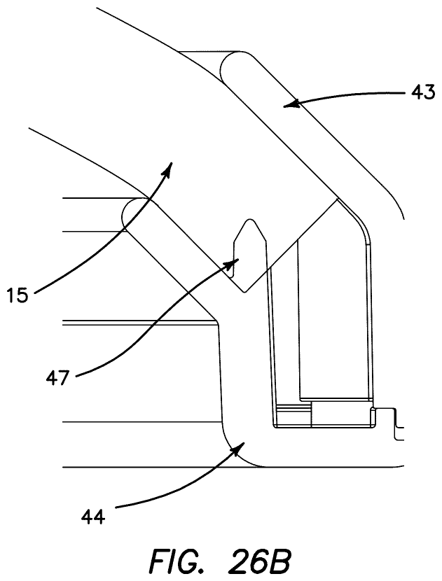

As shown in FIGS. 26A-26B, the bottom frame 44 includes upward protrusions 47 that are spaced around the perimeter of the bottom frame 44. These retaining protrusions 47 can also be present on the top frame 43, or both frame halves 43, 44. These teeth-like retaining protrusions 47 provide additional retention of the simulated abdominal wall 15 within the simulated abdominal wall frame 45 by pressing or biting into the simulated abdominal wall as it is compressed between the frame top 43 and frame bottom 44. With reference to FIG. 26B, a simulated abdominal wall 15 is compressed between the two frame halves 43, 44 and is pierced by a retaining protrusion 47. Alternatively, rubberized pads or double-sided tape may be employed together with or without the protrusions to retain the abdominal wall 15.

The design of the frame 45 allows the user to easily install and remove the wall/frame assembly from the surgical simulator enclosure. The geometry of the abdominal wall frame adds further support to the convex form of the simulated abdominal wall by utilizing an angled channel along the perimeter that the simulated abdominal wall is compressed between, which follows the natural shape of the simulated abdominal wall. Simply compressing the simulated abdominal wall between flat frame halves would result in significantly reduced support for the convex form and feel of the simulated abdominal wall, which would likely result in unwanted inversion during normal use.

The methods described above rely on a bent lamination mechanism formed in part by successively gluing surfaces together that have been made to curve. A structure that maintains the desired curvature emerges with each additional layer. The first method combines this gluing of curved layers with cutouts that have been made in the shape of a curved surface projected onto a flat surface. Different cutout patterns are alternated so that the seams of the cutouts do not align to weaken the structure, or alternatively, a cutout may be displaced/rotated with respect to the previous later having the same pattern to offset the seams from each other.

The second method uses vacuum forming to achieve curved surfaces and avoids seams across the surface altogether. Flat sheets of foam are placed over a negative cavity vacuum mold, a frame is placed over the foam to make an air-tight seal, and the vacuum mold is evacuated. As the vacuum is pulled, heat is applied to the foam, which allows the foam to yield and stretch into the mold cavity. When a new layer is to be added, a multitude of holes are poked through the previously-formed foam layers. Adhesive is applied between the layers so that they form a bond across the entire curved surface. After several layers of foam have been laminated together, the work-piece begins to maintain the curved shape of the mold. By adding or removing layers, the tactile response of the foam layers can be tailored for more lifelike feel.

Additionally, rigid or semi-rigid pieces may be added between the foam layers to simulate bony or other anatomy in any of the methods described herein. It should be noted that these bony inserts are not required for structural support. Instead, the bony inserts give the user landmarks for proper port placement, and also prevent port placement in the wrong area. Palpation is a common technique used for proper port placement, which is a crucial part of a successful procedure, and the bony inserts permit the user to train on palpation and proper port placement successfully. The bony inserts advantageously improve the realistic feel of the model.

It should be noted that while two methods are described here for layering pre-made foam sheets in order to create a curved surface with structural integrity, it would also be possible to create a casting mold that allows the user to sequentially build up a multitude of curved layers that are adhered to one another across their entire surface.

It is understood that various modifications may be made to the embodiments disclosed herein. Therefore, the above description should not be construed as limiting, but merely as exemplifications of preferred embodiments. Those skilled in the art will envision other modifications within the scope and spirit of the present disclosure.

We claim:

1. A method for making a simulated abdominal wall having a unitary dome body for use in surgical training, the method comprising the steps of:
providing a mold having a domed-shape mold cavity;
providing a plurality of planar cutouts of domed projections;
assembling each cutout into a dome having seams;
nesting each assembled cutout consecutively inside the domed-shape mold cavity such that the seams of adjacent cutouts do not align; and
adhering adjacent cutouts.

2. The method of claim 1 wherein the plurality of planar cutouts are of two or more different domed projections.

3. The method claim 1 wherein at least two adjacent cutouts inside the domed-shape mold cavity have the same domed projections.

4. The method of claim 3 further comprising the step of offsetting the seams of adjacent cutouts having the same domed projections, wherein the offsetting step comprises rotating or displacing one cutout relative to the other cutout of the adjacent cutouts.

5. The method of claim 1 further comprising the step of providing a bony insert between two adjacent cutouts; the two adjacent cutouts being assembled and nested inside the domed-shape mold cavity.

6. The method of claim 5 wherein the step of providing a bony insert further comprises adhering the bony insert to one or more of the two adjacent cutouts using adhesive.

7. The method of claim 5 wherein the bony insert is made from a material selected from the group consisting of polypropylene, styrene, polyethylene, nylon, paper, cardstock, polyvinyl chloride, polyethylene terephthalate, polyethylene, terephthalate glycol-modified, and acetal homopolymer resin.

8. The method of claim 5 wherein the bony insert simulates one or more of a bone, cartilage, muscle, tumor, blood vessels and nerves.

9. The method of claim 1 wherein the step of adhering adjacent cutouts comprises the step of applying adhesive between inner and outer surfaces of adjacent cutouts assembled and nested inside the domed-shape mold cavity.

10. The method of claim 9 wherein the adhesive is applied outside the location of seems of each adjacent cutouts.

11. The method of claim 1 further comprising the step of repeating the assembling, nesting and adhering steps to form the simulated abdominal wall with a plurality of domed cutout layers having the unitary dome body.

12. The method of claim 11 further comprising the steps of:
removing the plurality of domed cutouts layers having the unitary dome body from the domed-shape mold cavity;
providing a planar skin layer comprising a planar silicone layer cured onto a planar foam layer, thereby adhering the silicone to the foam; and
applying the planar skin layer to a convex surface of the plurality of domed cutouts layers.

13. The method of claim 12 wherein the step of applying the planar skin layer comprises stretching and adhering the planar skin layer onto the convex surface of the plurality of domed cutout layers, covering all seams and leaving a smooth convex surface.

14. The method of claim 12 wherein the step of applying the planar skin layer further comprises the steps of:
deforming the planar skin layer into a domed-shape skin layer having an inner surface made of foam and an outer surface made of cured silicone;
nesting the plurality of domed cutouts layers having the unitary dome body inside the domed-shape skin layer such that a convex outer surface of the plurality of domed cutouts layers faces the inner surface of the domed-shape skin layer;
applying adhesive between the domed-shape skin layer and the plurality of domed cutouts layers; and
pressing-down the plurality of domed cutouts layers and the domed-shape skin layer into the vacuum plenum or mold using a weight plug.

15. The method of claim 14 wherein the planar skin layer is deformed into the domed-shape skin layer by exposure to heat in a vacuum plenum or mold, and wherein the nesting step is carried out inside the vacuum plenum or mold after the deforming step.

16. The method of claim 14 wherein the pressing-down step is carried out by placing the weight plug on top of the plurality of domed cutouts layers and the domed-shape skin layer inside the vacuum plenum or mold.

17. The method of claim 1 further comprising the steps of:
providing a frame and a laparoscopic surgical training device;
inserting the simulated abdominal wall having the unitary dome body into the frame; the simulated abdominal wall being penetrable by a surgical trocar; and
connecting the frame to the laparoscopic surgical training device after the inserting step.

18. The method of claim 17 wherein the step of providing a frame comprises providing a frame having an angled channel formed between a top frame and a bottom frame; the angled channel following a contour of the simulated abdominal wall having the unitary dome body.

19. The method of claim 1 wherein the unitary dome body comprises a convex outer surface and a concave inner surface; the convex outer surface curving in at least two directions.

20. A simulated abdominal wall produced by the method of claim 1.
